(19) United States
(12) Patent Application Publication
(10) Pub. No.: US 2013/0038730 A1
(43) Pub. Date: Feb. 14, 2013

(54) TRANSPARENT VIDEO SCREEN AND ALTERNATE REVERSE CAMERA MONITOR

(71) Applicants: Don Peterson, Belvidere, IL (US); Sheldon Waite, Mundelein, IL (US); Thomas A. Brey, Lake In The Hills, IL (US)

(72) Inventors: Don Peterson, Belvidere, IL (US); Sheldon Waite, Mundelein, IL (US); Thomas A. Brey, Lake In The Hills, IL (US)

(73) Assignee: CONTINENTAL AUTOMOTIVE SYSTEMS, INC., Deer Park, IL (US)

(21) Appl. No.: 13/205,751

(22) Filed: Aug. 9, 2011

(51) Int. Cl. H04N 7/18

(52) U.S. Cl. 348/148; 348/E07.085

(57) ABSTRACT

An apparatus and method by which a rear-facing, ceiling-mounted entertainment display for a vehicle can be made transparent or virtually transparent to a vehicle's driver uses a camera and a second, forward-facing display panel on which an image what the entertainment display blocks from the driver's view. The camera is attached to the entertainment display and captures image-forming light blocked to the driver's rear-view mirror by the downwardly extending entertainment display. The second display panel projects forwardly, i.e., toward the rear-view mirror, what the camera sees looking rearwardly.

### BACKGROUND

Some vehicles now provide entertainment screens for rear passengers, which are mounted on the ceiling or headliner of the vehicle and either drop down or are mounted to extend downwardly from the headliner. It is well-known that such screens partially block the driver's rear-view mirror field of view. Other vehicles provide screens on the seatbacks of front seats but installing multiple screens is more expensive than a single headliner-mounted display screen.

### BRIEF DESCRIPTION OF THE DRAWINGS

FIG. 1 is a cross-sectional view of an automobile having a quasi-transparent video display screen for rear passengers;

FIG. 2 is a top view of the vehicle shown in FIG. 1;

FIG. 3 is a cross-sectional view of an alternate embodiment of a vehicle having a quasi-transparent video screen;

FIG. 4 is a cross-sectional view of the vehicle showing an alternate reverse camera monitor location;

FIG. 5 depicts a boat on a trailer to illustrates a shortcoming of a rearward-directed camera;

FIG. 6 is an alternate embodiment of an alternate reverse camera monitor;

FIG. 7 is an isolated view of a vehicle dashboard having an included display;

FIG. 8 shows how a drivers view can be obscured by an attached trailer, even when using a camera facing rearward from a vehicle;

FIG. 9 is a view of the dashboard display and display screen;

FIG. 10 is an isolated view of the display screen of FIG. 9 showing the image captured by a rear-facing camera attached to a trailer;

FIG. 11 depicts an alternate location for a display screen on which an image captured by a rear-facing camera can be displayed; and

FIG. 12 depicts steps of a method for filling an obstructed field of view

### DETAILED DESCRIPTION

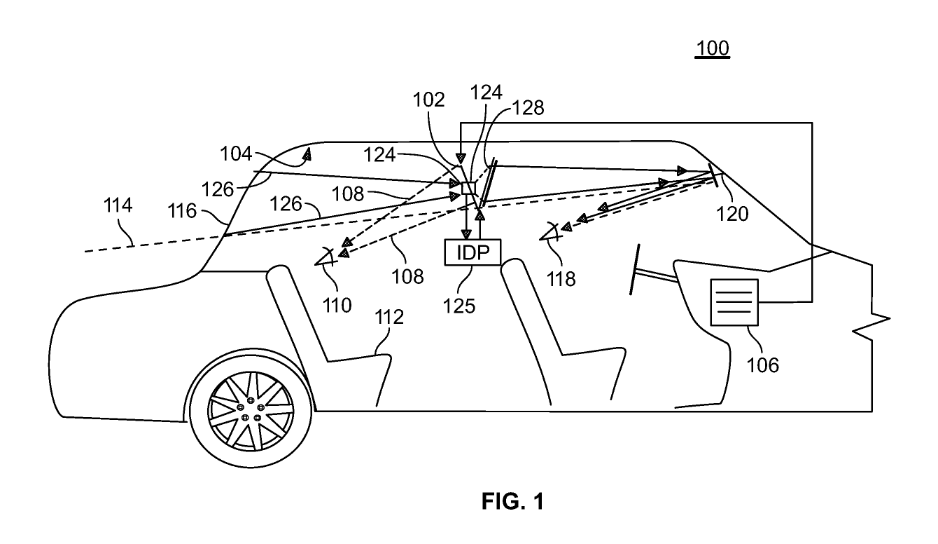

FIG. 1 is a cross-sectional view of a vehicle 100 having a display panel or entertainment screen 102 attached to or configured to drop down from the roof or headliner 104. The display panel 102 is realized as a panel, such as a plasma or liquid crystal display on which text and graphics are displayed on the display panel 102 in frames. Motion or video can thus be provided on the display device as a series of image frames

The display device 102 is capable of displaying image frames that it receives from a vehicle-mounted entertainment/information system 106. Such systems are also sometimes referred to as “infotainment” systems. Light 108 emitted from the display panel 102 is directed rearwardly, i.e. toward the rear of the vehicle 100. A viewer 110 seated in the rear seat 112 can see images emitted from the display screen 102 whereas the driver 118 cannot.

As stated above, an unfortunate consequence of a display panel 102 projecting downwardly from the roof or headliner 104 and which is configured for back seat passengers to view, is that it blocks at least some of the driver's rear-view-mirror, field of view, i.e., what the driver 118 would see in his or her rear view mirror 120. A display device 102, which is mounted behind the driver 118 and extends downwardly from the head liner 104, blocks some of the driver's view to the rear of the vehicle 100. Reference numeral 114 identifies a reference line above which light entering the rear windshield 116 will not reach the mirror 120 and thus cannot be seen by the driver 118 when he or she looks through the rear-view mirror 120. The display panel 102 thus creates a partially obstructed field of view. In FIG. 1, light or images above the reference line 114 are blocked from view and thus within a partially-obstructed field of view.

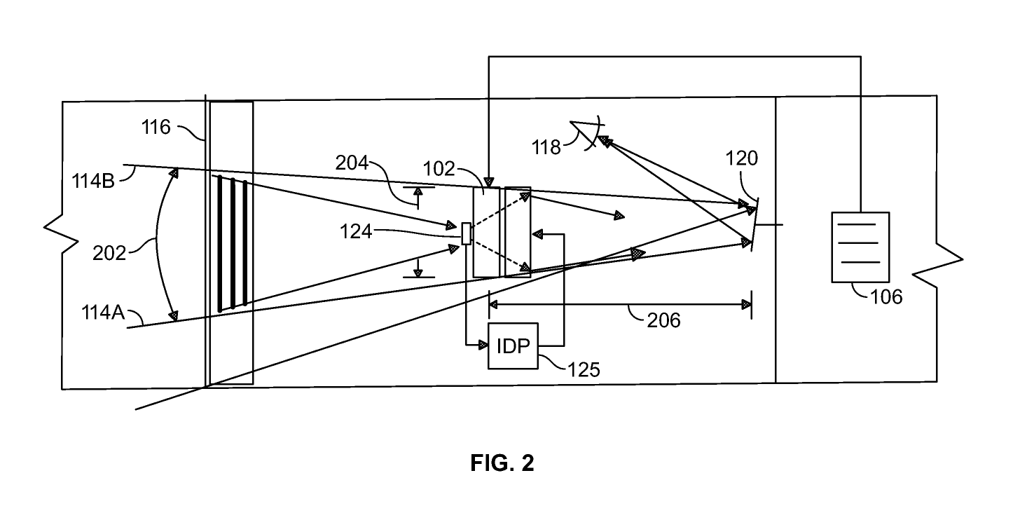

FIG. 2 is a top view of the vehicle shown in FIG. 1 showing the relative location of the driver 118, the rear-view mirror 120, the rear window 116 and the display panel 102. FIG. 2 also shows that the partially obstructed field of view that is above the reference line 114 subtends an angle 202 which is identified as the angle between the reference lines 114A and 114B. Those of ordinary skill in the art will recognize that the magnitude of the angle 200 is determined by the width 204 of the display screen 102 as well as the separation distance 206 between the mirror 120 and the display screen 102.

Referring to both FIG. 1 and FIG. 2, the view-obstructing display screen 102 is made quasi-transparent by filling the partially obstructed field of view with an image of what would otherwise be seen by the driver 118 if the view-obstructing display screen 102 was not there or if it were to be removed. In FIG. 1 and FIG. 2, a camera 124 is attached to the display device 102 and directed rearwardly. The camera 124 is adjusted and configured to capture light 126 entering the rear windshield 116 and which is above reference line 114 and therefore within the obstructed field of view. Images captured by the camera 124 are sent to, and processed by, an image display processor 125. The image display processor 125 sends information to a second display panel 128 configured to display an image frame or series of image frames forwardly, i.e., toward the rear-view mirror 120. The second display panel 128 thus directs image-forming light toward the front of the car while the first panel directs its own, image-forming light toward the rear of the car.

When images captured by the camera 124 are displayed from the second panel 120 and viewed by the driver 118 through the rear-view mirror 120, the images on the second panel 120 correspond to what would be seen by the driver 118 if the first panel 102 were not present. The second-panel images thus make the first panel 102 virtually transparent. The image captured by the camera 124 and displayed on the forward-facing second display device 128 thus provides a facsimile of the partially obstructed field of view caused by the first display panel 102.

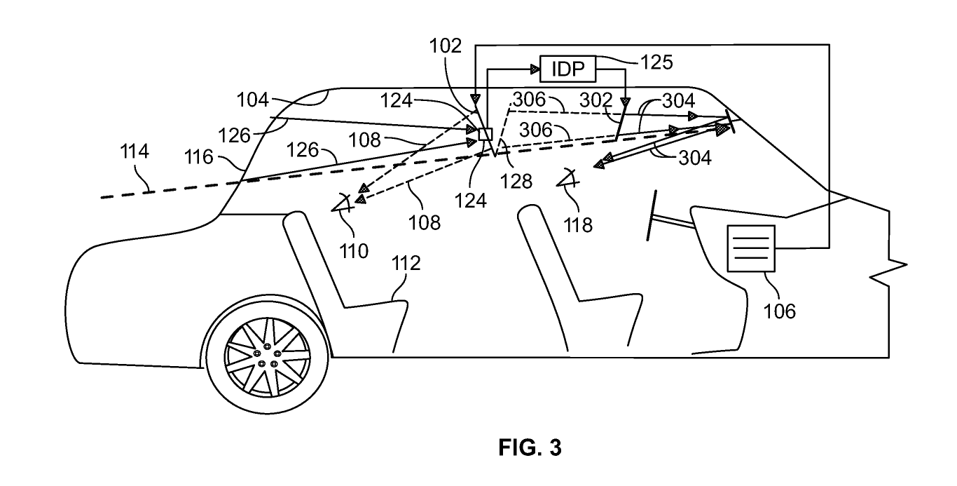

FIG. 3 is an alternate embodiment of a quasi-transparent display panel. The second display panel 128 shown in FIG. 1 and FIG. 2 is moved forwardly in the car to be closer to the rear-view mirror 120. The second display panel is identified in FIG. 3 by reference numeral 302. Since it is closer to the rear-view mirror and therefore closer to the drive 118, it can be made smaller but will nevertheless project the same image to the driver 118 that the larger, second display screen 128 would project.

In FIG. 3, reference numeral 304 identifies the forwardly-directed light rays emitted from the second display panel 302. When those rays 304 are extended rearwardly, as shown by the broken lines identified by reference numeral 306, they extend to where the larger screen shown in FIGS. 1 and 2 was located. Moving the second display panel closer to the rear-view mirror 120 thus enables the second display panel to be reduced in size as shown in FIG. 3. Since the two display panels 102 and 302 have a different size and/or shape, the two display panels 102 and 302 are considered herein to have shape attributes that are dissimilar.

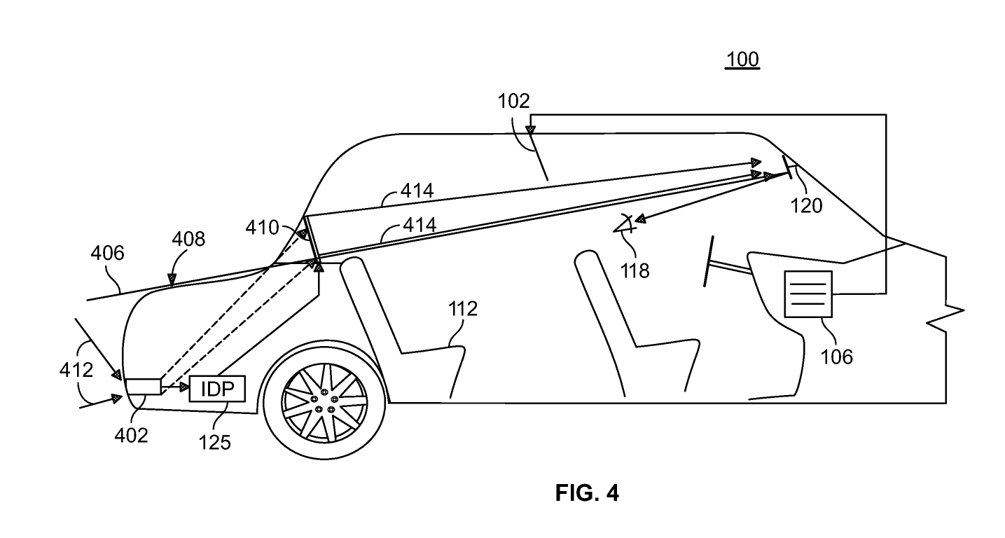

FIG. 4 depicts an alternate embodiment of a quasi-transparent display screen 102 wherein a rearwardly directed camera 402, mounted outside the vehicle's passenger compartment, captures images in a driver's obstructed field of view. Reference line 406 shows that light or images below the trunk lid 408 cannot be seen by the driver 118 when looking through the rear-view mirror 120. Images below reference line 406 are thus obstructed from view by at least the trunk lid 408. The camera 402, which faces rearwardly and which near ground level, captures light 412 that form images that can be seen behind the vehicle 100. The images or light captured by the camera 412 are projected from a forward-oriented display device 410 located behind the rear seat 112. Light 414 from the forwardly-directed display screen 410 can thus be seen in the rear-view mirror 120, or when the driver faces rearwardly, as usually happens when the driver 118 is attempting to back the vehicle 100. An object behind the vehicle will thus be captured by the camera 402 and displayed by the display panel 410 which is located in the passenger compartment to direct light toward the front of the vehicle, i.e., toward the driver 118 and the rear-view mirror 120.

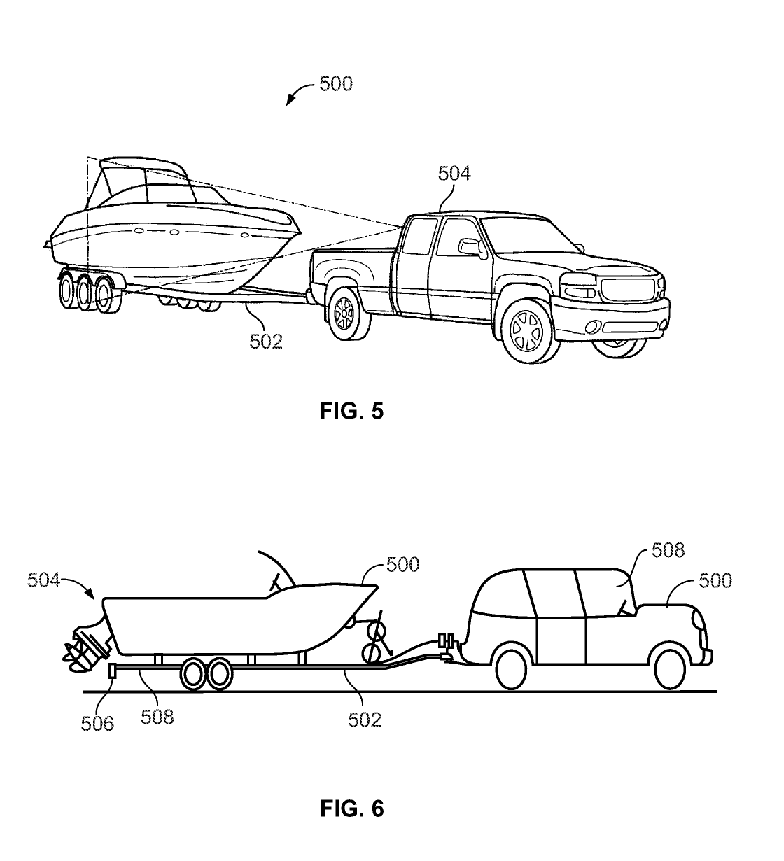

FIG. 5 depicts a boat 500 loaded onto a trailer, which is attached to a vehicle 504. FIG. 5 thus illustrates a shortcoming of a rearward-directed camera that is attached to the rear of a vehicle: the boat and trailer block most of the driver's rearward field of view.

The rear-view obstruction caused by a trailer 502 and a load 500 it carries can be overcome by repositioning the camera 402 depicted in FIG. 4 to the rear end or back of the trailer 502 or, by co-locating a second camera at the back end or rear end of the trailer 502. Images captured by a second camera attached to a trailer can be displayed on either a dashboard-located screen or a forward-oriented display device 410 located behind the rear sear 112 as shown in FIG. 4. In another embodiment, images captured by a camera mounted at the rear of a trailer and/or its load can be projected on to both a dashboard-located screen and a rear-located, forward-projecting screen as shown in FIG. 4.

FIG. 6 is an alternate embodiment of a reverse camera monitor. The rear or back end 504 of the boat 500 is above a rear-facing camera 506 that is attached to the rear or back end 508 of the trailer 502. The rear-facing camera 506 is configured and arranged to capture images behind the boat and/or trailer 502 and which are not visible to a driver located in the front 508 of the towing vehicle 500.

Images captured by the rear-facing camera 506 can be wirelessly transmitted from the camera 506 to a receiver located in the vehicle 500 using communications techniques described in the Applicant's co-pending patent application entitled “Smart Trailer,” filed on <DATE,> which is assigned to the assignee of this application and which is also identified by the Continental Corporation docket no. 2011P00245US. Alternatively, the images captured by the camera 506 can be provided via a cable or hard-wired connection to the vehicle 500.

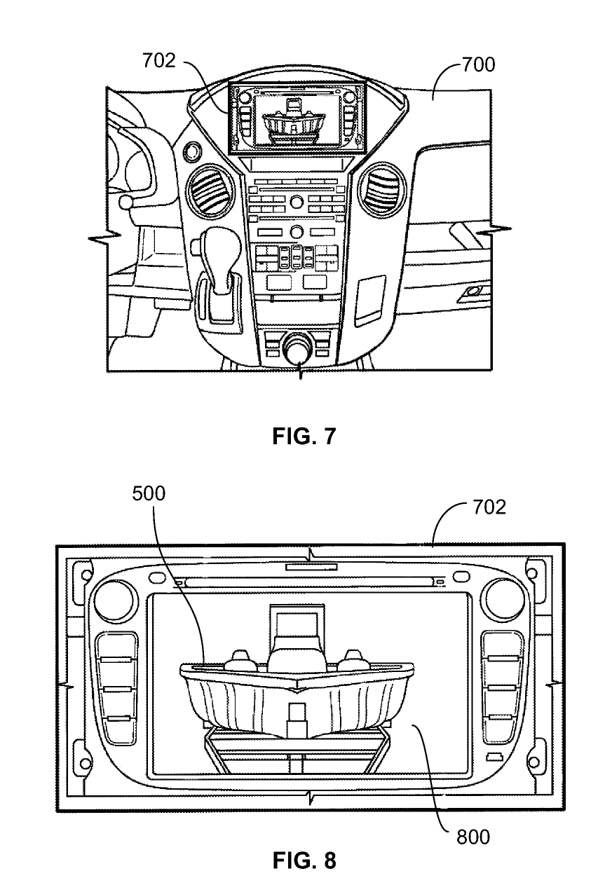

An important aspect of the rear-facing camera 506 and the images that it captures but which are obscured from the driver by the boat 500 and/or the trailer 502 is that the images can be displayed on either a dash-mounted display and/or a rear-located display. FIG. 7 is an isolated view of a vehicle dashboard 700 having an included display panel 702 visible to the driver of the vehicle when the driver is facing forward. FIG. 8 is an isolated view of the display screen 702 showing an image 800 that would be captured by a camera 402 attached to the rear of the towing vehicle 500. As FIG. 8 shows, the driver's view of the area behind the boat is obscured by the boat itself making it difficult to back up the trailer and boat.

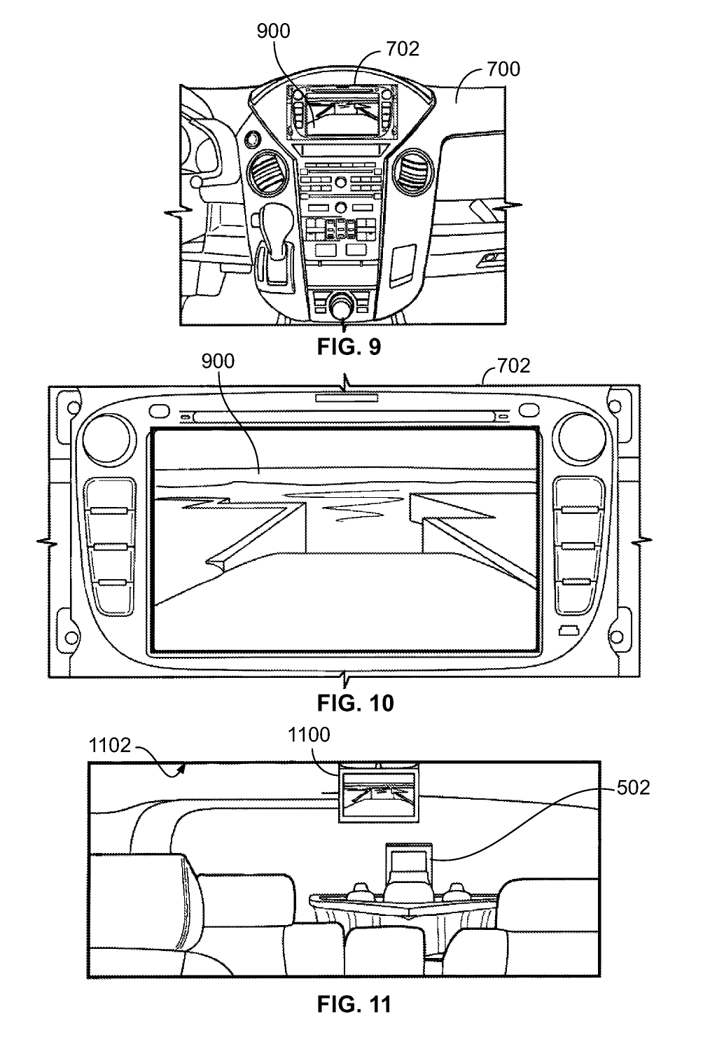

FIG. 9 is a view of the same dashboard 700 and the same display screen 702 but displaying instead an image captured by the rear-facing camera 506 located at the rear 508 of the trailer 502. FIG. 10 is an isolated view of the display screen 702 showing more clearly the image captured by the rear-facing camera 506. As can be seen in FIG. 10, the view behind the boat 500 and the trailer 502 is unobstructed.

FIG. 11 depicts an alternate location for a display screen 1100 on which the image captured by the rear-facing camera 506 can be displayed. In FIG. 11, the display screen 1100 is mounted at the rear of the passenger compartment of the vehicle and suspended from the headliner 1102 such that when the driver looks rearwardly he is able to see both the trailer and the boat it carries 502 as well as the field of view captured by the rear-facing camera 506 located at the back end of the trailer 502.

Mounting a second camera 506 at the back end of a trailer 502 carrying a load and displaying images it captures on either a dash-located monitor facing the driver or on a forward-facing monitor located at the rear of the passenger compartment provides an exceptionally improved field of view for the driver of a vehicle pulling a trailer.

In one embodiment, a single camera is moveable such that it can be attached to the rear of the vehicle 500 or removed and relocated to the rear of a trailer. In another embodiment two cameras are used with a selection of the camera input to display being a driver selection choice.

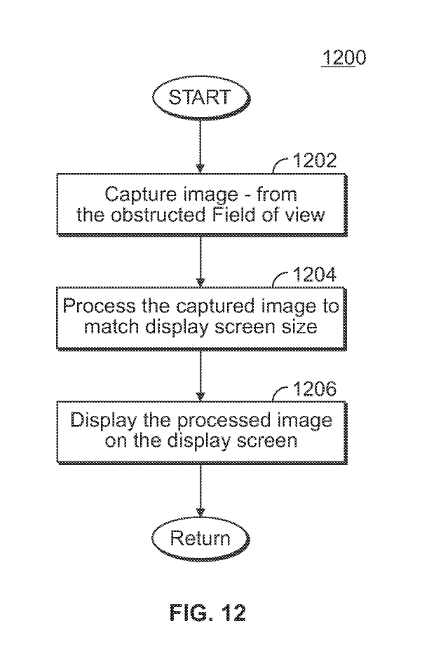

The embodiments described above practice the same method of at least partially filling a field of view that is at least partially obstructed by an object. That method can be best understood by reference to FIG. 12 which is a flowchart depicting the steps of the method 1200. The method begins at step 1202, which is to capture an image from the partially obstructed field of view using one or more cameras that are placed to “see” into the obstructed field. The image captured by a camera is preferably equal in size and shape to the obstruction.

Once the image or images of the obstructed field of view have been captured, they are processed in step 1204 to enable the display of the captured image on a display device that might have a different picture resolution and or image size. Raw image files produced by a camera or other type of image detector can be passed-through an image data processor 125, which refers to any processor capable of accepting raw image data from a camera or detector and which is able to perform one or more predefined operations or transformations on each image. Such operations include but are not limited to cropping or re-sizing an original image obtained from the camera or image detector, adjusting its color to improve image quality and/or eliminating visual artifacts. By way of example, the camera 124 in FIG. 1 might capture images at a picture element or pixel resolution of 2560×1920 dot or pixels-per-inch whereas the display device 128 might only be capable of displaying 1024×768 DPI. Passing raw image data through a cropping/scaling processing performed by the image data processor 125 thus enables the camera output to be used to generate a facsimile of what the driver 118 would see when looking through the rear view mirror 120. Step 1204 includes processing a captured image to frame it and size it for a corresponding forwardly-directed display device. At step 1206 the captured image is displayed on a display device located in front of the obstruction.

The foregoing description is for purposes of illustration only. The true scope of the invention is set forth in the appurtenant claims.

What is claimed is:

1. A vehicle display panel comprising:
a. a camera configured to capture an image corresponding to a partially obstructed field of view of a vehicle operator; and
b. a first display panel, configured to display the captured image to the vehicle operator.

2. The vehicle display panel of claim 1, wherein the camera and first display panel are configured such that the captured image is displayed to the vehicle operator as a facsimile of the partially obstructed field of view.

3. The vehicle display panel of claim 1 wherein the first display panel is located proximate to the rear of a vehicle passenger compartment and images displayed thereon are projected toward the front of the vehicle passenger compartment.

4. The vehicle display panel of claim 1, wherein the camera is configured to capture an image of a vehicle blind spot.

5. A vehicle comprising:
a. a first display panel configured to display at least one image frame from a first stream of image frames obtained from a first source, the first stream of image frames being viewable from a first direction;
b. an second display panel configured to display at least one image from a second stream of image frames obtained from a second source, the second stream of image frame viewable from a second direction, the first and second directions being opposite, the second display panel partially obstructing a field of view from the first direction from in front of the first display panel; and
c. a camera configured to capture at least one image from the first direction, and configured to provide the at least one image frame to the first display panel.

6. The vehicle of claim 5, wherein the camera is configured to capture at least one image, which when displayed on the first display panel, substantially fills the first display panel with an image of the obstructed portion of the field of view from the first direction.

7. The vehicle of claim 6, wherein the first and second display panels have corresponding attributes of size and shape and wherein at least one of the attributes is similar.

8. The vehicle of claim 6, wherein the first and second display panels have corresponding attributes of size and shape and wherein at least one of the attributes is dissimilar.

9. The vehicle of claim 5, wherein the camera is attached to at least one of the first display panel and the second display panel.

10. A display system for a vehicle having a front end and a rear end, and having a passenger compartment with a front area and a rear area, the system comprising:
a. a camera directed rearward of the vehicle, the camera being configured to generate signals representing an image of an object in a field behind the vehicle; and
b. a display panel configured to display an image formed by light emitted from the display panel, the light emitted from the panel being directed generally toward the front of the vehicle.

11. The display system of claim 10, wherein the display panel is located in the rear area of the passenger compartment.

12. The display system of claim 10, wherein the object is obscured from view and wherein the display panel displays an image of the obscured object to the vehicle operator.

13. The system of claim 10, wherein the vehicle is operable in a reverse mode and wherein the camera and display panel are configured to be operational when the vehicle in is the reverse mode.

14. The system of claim 10, wherein the camera is attached to an underside of the vehicle.

15. The system of claim 10, wherein the camera is attached to a rear-facing surface of the vehicle.

16. The system of claim 10, wherein the display panel is configured to display a mirror image of an image captured by the camera.

17. A method of filling a field of view, at least partially obstructed by an object, the method comprising:
a. capturing a first image from the partially obstructed field of view; and
b. displaying the first image on a first display panel located in front of the object, the first image and first display panel being configured such that the first image is a facsimile of the at least partially obstructed field of view.

18. The method of claim 17, further comprising the step of:
a. processing the size and shape of the first image to render a displayed image that is substantially identical to the obstructed portion of the field of view.

19. The method of claim 17 further comprising the step of displaying a second image on a second display device located behind the first display device.

20. The method of claim 17 further comprising the step of displaying a second image on a second display device laterally displaced from the first display device.
